(19) United States
(12) Patent Application Publication
(10) Pub. No.: US 2014/0196228 A1
(43) Pub. Date: Jul. 17, 2014

(54) TOOTHBRUSH

(71) Applicant: Mikio Saito, Kanagawa (JP)

(72) Inventor: Mikio Saito, Kanagawa (JP)

(21) Appl. No.: 14/115,944

(22) PCT Filed: Apr. 27, 2012
(86) PCT No.: PCT/JP2012/061784

§ 371 Date: Jan. 16, 2014

(30) Foreign Application Priority Data
May 9, 2011 (JP) 2011-104150

(51) Int. Cl. A61C 17/22

(52) U.S. Cl. CPC A61C 17/22
USPC 15/28

(57) ABSTRACT

A polygonal toothbrush that enables bristles to more easily enter spaces between teeth to remove plaque, and as a consequence, can have a preventive effect on periodontal disease and gingivitis, as well as a massaging effect on gums and the like. A rotating-receiving shaft of a brush material is fitted and attached to a rotating shaft provided on a handle part, and a guide plate that guides the rotation of the rotating-receiving shaft is provided on the handle part such that the friction resistance between the rotating shaft, the rotating-receiving shaft, and the guide plate can be varied; or the brush material is attached, at a rotating-receiving shaft receiving hole thereof, to the rotating shaft provided on the handle part such that the friction resistance between the rotating shaft and the rotating-receiving shaft receiving hole of the brush material can be varied.

### TECHNICAL FIELD

The present invention relates to a toothbrush having a gear shape and a polygonal shape.

### BACKGROUND OF THE INVENTION

For general toothbrushes conventionally used, though forms, length, thickness, hardness and the like of bristle tips are different, toothbrushes vertically bristled in a head part of a handle, toothbrushes in which a surface of the bristle tip of a brush part vertically bristled is formed in a chevron shape, and the like are provided.

In addition, not the toothbrushes vertically bristled in a head part of a handle, but toothbrushes which are provided to be in a circular shape to rotate and rod-shaped toothbrushes in which a circular brush material is provided vertically to a head part of a rod-shaped handle are provided.

Moreover, in the case of the toothbrushes having a circular shape to rotate 360 degrees, little friction resistance between a brush part and a rotating shaft is caused during toothbrushing, thus being toothbrushes for toothbrushing by simply moving on front and rear faces of the teeth side to side and up and down.

Further, in the case of the toothbrushes having a circular shape, there is a drawback that, because of having the circular shape, bristle tips of the brush part are difficult to enter spaces between teeth during rotation.

### SUMMARY OF THE INVENTION

As described above, in the case of conventional flat brushes, rod-shaped toothbrushes, toothbrushes having a circular shape to rotate, and the like, simply rotating on front and rear faces of teeth and the like side to side and up and down, bristle tips are difficult to enter spaces between teeth to which plaque as the cause of periodontal disease is easily attached, and possibility of the effect of removing the plaque is doubtful in some degree.

The present invention is to solve the above-described problems that a configuration of conventional toothbrushes had.

Description will be given for a toothbrush having a gear shape and a polygonal shape of the present invention in order to solve the above-described problems.

The toothbrush is characterized in that a rotating-shaft receiving shaft 8 of a brush material is fitted and attached to a rotating shaft 9 provided on a handle part 13, and a guide plate 14 that guides rotation of the rotating-shaft receiving shaft 8 is provided on the handle part 13 such that the friction resistance between the rotating shaft 9, the rotating-shaft receiving shaft 8, and the guide plate 14 can be varied.

Moreover, the toothbrush is characterized in that the brush material 1 is attached, at a rotating-shaft receiving hole 10 thereof, to the rotating shaft 9 provided on the handle part 13 such that the friction resistance between the rotating shaft 9 and the rotating-shaft receiving hole 10 of the brush material 1 can be varied.

Moreover, the toothbrush is characterized in that the brush material 1 is attached at a rotation angle different from the rotating-shaft receiving shaft 8.

Further, the toothbrush is characterized in that as means for attaching the brush material 1 to the rotating shaft 9, attachment is performed at a rotation angle same with the rotating-shaft receiving shaft 8.

Description will be given for a toothbrush having a gear shape of FIGS. 1 to 11. Mounting parts 11 having holes 10a for attaching the rotating shaft 9 provided at right and left of a fore-end part 12 of the handle part 13 and the guide plate 14 for guiding rotation of the rotating-shaft receiving shaft 8 inside the right and left mounting parts 11 are provided. Furthermore, the toothbrush having a gear shape 3 is such that at a center part of the brush material 1 forming the brush part 2, an opening part 7 having a polygonal shape for attaching to the rotating-shaft receiving shaft 8 and several brush material 1 whose outer peripheral is provided in the gear shape 3 are attached at the same rotation angle, and the rotating shaft 9 is inserted into a receiving hole 10 of the rotating-shaft receiving shaft 8 to be attached to a hole 10a of the mounting part 11 such that the friction resistance between the rotating shaft 9, the rotating-shaft receiving shaft 8 and the guide plate 14 can be varied.

Moreover, description will be given for a toothbrush having a polygonal shape of FIGS. 12 to 20. Similarly to the above, the toothbrush is such that a hole 12 for attaching the rotating shaft 9 is provided on the mounting parts 11 on right and left of the fore-end part 12 of the handle part 3, an opening part 7 at the center part and the brush material 1 provided to have a polygonal shape with the outer peripheral are attached to the rotating-shaft receiving shaft 8 provided with the rotating-shaft receiving hole 10 at the same or different rotation angle, the rotating shaft 9 is inserted into the receiving hole 10 so as to be attached to the hole 10a of the mounting part, and is the toothbrush having a polygonal shape configured such that the friction resistance between the rotating shaft 9 and the rotating-shaft receiving shafts 8 and 8a can be varied.

Moreover, the toothbrush is able to significantly improve possibility of the effect of, of course, massaging on gums and removing plaque and the like during toothbrushing, of course, on the front and rear faces of teeth while always keeping the gear shape and the polygonal shape during usage by being provided so as to rotate when a certain amount of the friction resistance is caused, and bristle tips easily enter space between teeth because of being provided in the gear shape and the polygonal shape.

Moreover, it is the toothbrush having the gear shape and the polygonal shape, in the case of toothbrushing on the rear face of teeth using the toothbrush or the like, the toothbrush rotates not only on the front face of teeth for toothbrushing, but as the effect by providing the brush part to have the gear shape and the polygonal shape, the fore-end part of the brush part easily enters spaces between teeth, and by improving the effect of, of course, massaging on gums and removing plaque and the like, a preventive effect of tartar becomes possible, resulting in making a substantial contribution to prevention of periodontal disease and the like.

Furthermore, the brush material 1 is such that, by providing the opening part 7 at the center part of the several (several rows of) brush material 1 forming brush parts 2, 2a2b and the rotating-shaft receiving shaft 8 to have the same shape, rotation is performed while always keeping the same shape during rotation, but by providing the opening part 7 so as to be rotatable freely when the opening part 7 of a part of the brush material 1 is attached to the rotating-shaft receiving shaft 8, the part of the brush material 1 forming the brush part 2, 2a2b rotates while keeping the same shape as well as the part is also able to be attached so as to be rotatable freely.

Moreover, the shape of the brush part in the gear shape 3 may be provided to be an appropriate shape without limitation, and the brush part in the polygonal shape may be also in the triangular or more polygonal shape without limitation.

Moreover, the shape of the opening part 7 provided at the center part of the brush material 1 and the shape of the rotating-shaft receiving shaft 8 may be also provided to have an appropriate shape suitable for the above-described action without limitation.

Moreover, the number of guide plates 14 provided inside the mounting part 11 of the fore-end part 12 of the handle part 13 may be provided as appropriate without limitation.

Moreover, material and the like of the brush material 1 are not limited, though general nylon and the like are preferably used.

Further, by attaching the brush material 1 having other polygonal shape, for example, like the brush material having a square shape shown in FIG. 15 to the rotating-shaft receiving shaft 8 at a different angle, it is possible to provide the toothbrush having the gear shape from side view variously.

As described above, a toothbrush of the present invention is a toothbrush having a brush part formed in a gear shape and a polygonal shape.

Differently from a conventional flat brush and a rotary brush having a circular shape, by providing the brush part of the toothbrush to have a gear shape and a polygonal shape, a fore-end part of bristle of the brush part easily enters spaces between teeth during toothbrushing, and as a consequence, an effect of removing plaque and the like can be expected.

In addition, it is the toothbrush, in which particularly by being provided in the gear shape and the polygonal shape, it is possible to easily contact spaces between teeth, and it can be greatly expected to increase the possibility of removing the plaque which is regarded as the cause of periodontal disease and the like.

Further, the friction resistance between the rotating shaft, the rotating-shaft receiving shaft, and the fore-end part of the guide plate provided to be also used as a washer can be varied, so that it is configured such that providing so as to be rotatable without resistance during rotation is possible as well as providing so as to be rotatable during a certain amount of the friction resistance is generated is possible.

Moreover, it is the toothbrush having the gear shape and the polygonal shape, in which the brush material is able to be provided by simple means, so that a toothbrush body is also able to be provided at low price.

As described above, the toothbrush having the gear shape and the polygonal shape is the toothbrush that has a non-conventional shape, in which the rotating-shaft receiving shaft to which the brush material is attached is provided so as to be variable by the action of the guide plate and the rotating shaft, so that it is possible to make a toothbrush part rotatable variously for each intended use, resulting that the bristle tips of the brush part abuts a tooth face and spaces uniformly and there is no unbrushed part.

Moreover, since most people brush his/her teeth with a dominant hand during toothbrushing, few people changes gripping hands, so that an unbrushed part is likely to be generated with the conventional toothbrushes.

Description will be given for embodiments of a toothbrush having a gear shape and a polygonal shape according to an example more specifically with reference to FIGS. 1 to 20. Note that, the scope of the present invention is described in the claims and, needless to say, not limited to the following embodiments.

### BRIEF DESCRIPTION OF THE DRAWINGS

FIG. 1 is a side view of a brush material in which bristles constituting a brush part is winded with a wire in a circular shape.

FIG. 2 is a side view of the brush material that A-A′ portion of FIG. 1 is cut and compressed.

FIG. 3 is a plan view in a B-B′ direction of the compressed brush material 1 of FIG. 2.

FIG. 4 is a plan view in which a center part of the brush material of FIG. 3 is subjected to ultrasonic welding.

FIG. 5 is a plan view in which the center part of the brush material of FIG. 4 and an outer peripheral are cut.

FIG. 6 is an enlarged perspective view of a rotating-shaft receiving shaft which is provided with a receiving hole for a rotating shaft of FIG. 7.

FIG. 7 is an enlarged perspective view of the rotating shaft for inserting into the receiving hole of the rotating-shaft receiving shaft of FIG. 6.

FIG. 8 is a side view of a fore-end part of a handle part that the brush material of FIG. 5 is attached to the handle part.

FIG. 9 is an enlarged transverse central section view of a C-C′ portion of FIG. 8.

FIG. 10 is an enlarged side view in a D-D′ direction of FIG. 8.

FIG. 11 is an enlarged center section view in an E-E′ direction of FIG. 8.

FIG. 12 is a plan view in which the center part of the brush material of FIG. 4 and the outer peripheral are cut.

FIG. 13 is a side view in which the brush material of FIG. 12 is attached to the rotating shaft.

FIG. 14 is a side view of a fore-end in which the brush material of FIG. 13 is attached to the handle part.

FIG. 15 is an enlarged transverse central section view of an F-F′ portion of FIG. 14.

FIG. 16 is an enlarged front view in a G-G′ direction of FIG. 14.

FIG. 17 is an enlarged section view showing an H-H′ direction of FIG. 14.

FIG. 18 is a plan view in which the center part of the brush material of FIG. 4 and the outer peripheral are cut.

FIG. 19 is a side view of a fore-end in which the brush material of FIG. 18 is attached to the handle part.

FIG. 20 is an enlarged transverse central section view of a J-J′ portion of FIG. 19.

FIG. 21 is a reference perspective view of other different rotating-shaft receiving shaft.

FIG. 22 is a reference perspective view of other different rotating-shaft receiving shaft.

FIG. 23 is a reference perspective view of the rotating shaft of FIGS. 22 and 23.

### DETAILED DESCRIPTION OF THE PREFERRED EMBODIMENTS

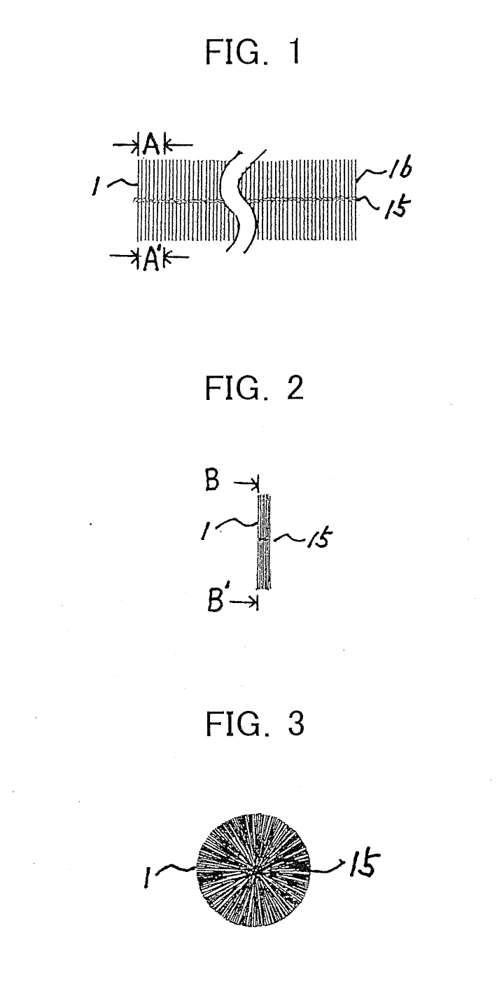

Description will be given below for an embodiment 1 based on FIG. 1 to FIG. 11.

FIG. 1 is a side view showing a state where a center part of bristles 16 serving as a basis of a brush material 1 is winded with a wire 15 in a cylindrical shape.

FIG. 2 is the brush material 1 that A-A′ portion of the bristles 16 in the cylindrical shape winded with the wire 15 in FIG. 1 is cut and the A-A′ portion is compressed.

FIG. 3 is a plan view showing a B-B′ method of the brush material 1 of FIG. 2 compressed in the cylindrical shape, in which 15 denotes a wire of the center part.

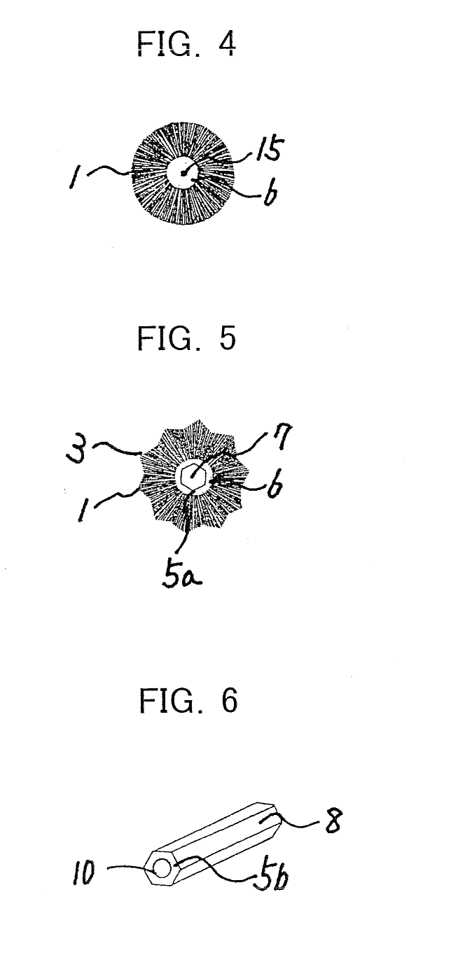

FIG. 4 shows a state where the center part of the compressed brush material 1 of FIG. 3 is subjected to ultrasonic welding 6, in which 15 denotes a wire.

FIG. 5 is the brush material 1 which is provided with an opening part 7 having a hexagonal shape 5a at the center part of the brush material 1 having the center part subjected to ultrasonic welding 6 in FIG. 4 and has outer peripheral provided in the gear shape 3.

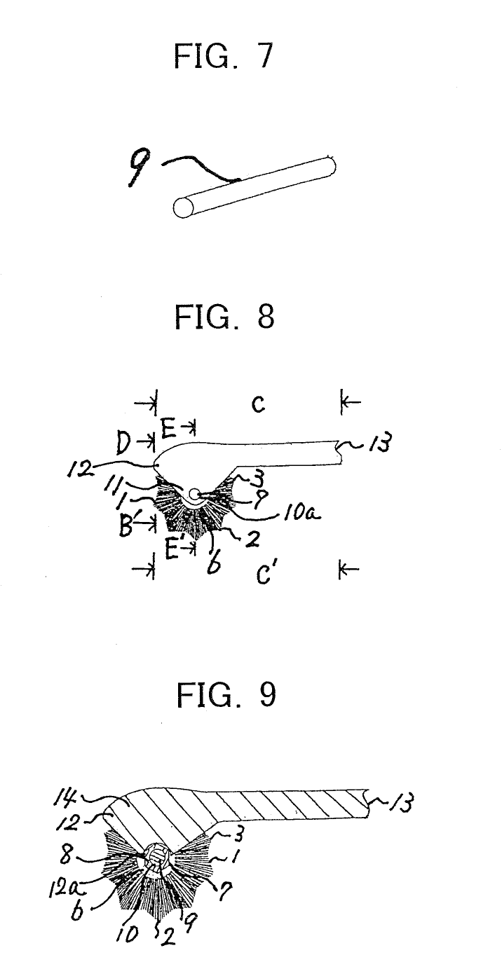

FIG. 6 is a rotating-shaft receiving shaft 8 having a hexagonal column shape 5b provided with a receiving hole 10 of a rotating shaft 9 in FIG. 7, and is the rotating-shaft receiving shaft 8 which is attached at a hole 10a of a mounting part 11 of a fore-end part 12 of a handle part 13 of FIG. 8 by attaching the brush material 1 explained in FIG. 5 to the rotating-shaft receiving shaft 8 and inserting the rotating shaft 9 into the receiving hole 10.

FIG. 7 is the rotating shaft 9 which is inserted into the receiving hole 10 provided at the rotating-shaft receiving shaft 8 of FIG. 6 and attached to the hole 10a of the mounting part 11 provided on the fore-end part 12 of the handle part 13 of FIG. 8.

In FIG. 8, the brush material 1 of FIG. 5 is attached to the rotating-shaft receiving shaft 8 of FIG. 6, and the rotating shaft 8 is inserted into the receiving hole 10 of the rotating-shaft receiving shaft 8 to be attached to the hole 10a of the mounting parts 11 at right and left of the fore-end part 12 of the handle part 13. 6 denotes a welding part, 3 denotes the brush material 1 having the gear shape, and 2 denotes a brush part.

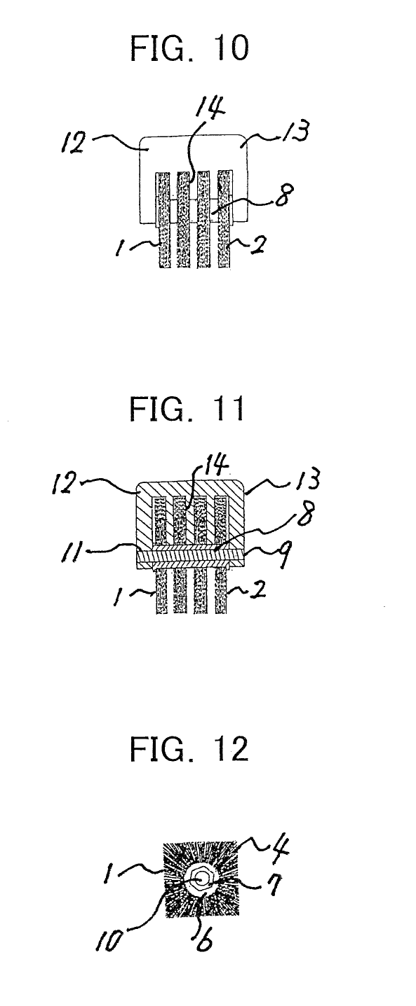

FIG. 9 is an enlarged transverse central section view of a C-C′ portion of FIG. 8. Moreover, it is also a section view of the central vertical direction of FIG. 10. 14 denotes a guide plate which is provided inside the mounting parts 11 at right and left of the fore end part 12 of the handle part 13 to guide the rotation of the rotating-shaft receiving shaft 8. Moreover, 2 denotes a brush part formed with the brush material 1 having the gear shape 3 and the brush material 1 provided with the opening part 1 attached to the rotating-shaft receiving shaft 8. Furthermore, 9 denotes the rotating shaft which is inserted into the receiving hole 10 of the rotating-shaft receiving shaft 8, 6 denotes the welding part, and 12a denotes a fore-end part of the guide plate 14.

FIG. 10 is an enlarged front view showing a D-D′ method in the fore-end part 12 of the handle part 13 of FIG. 8. As shown in the section view of FIG. 11 for the fore-end part 12 of the handle part 13, the toothbrush having the gear shape is that the brush material attached to the rotating-shaft receiving shaft 8 is provided at the holes of the right and left mounting parts 11, and the brush material 1 is provided between the guide plates 14 provided inside the mounting part 11 to form the brush part 2.

FIG. 11 is an enlarged center section view in an E-E′ direction of FIG. 8. As described in FIGS. 8 and 9 above, the toothbrush is that the brush material is attached to rotating-shaft receiving shaft 8, the brush part 2 formed with the brush material 1 is attached between the guide plates 14 provided inside the mounting parts 11 at right and left of the fore-end part 12 of the handle part 13, and the rotating shaft 9 is attached to the hole 10a of the mounting parts 11. The toothbrush is characterized in that the rotating-shaft receiving shaft 8 of the brush material 1 is fitted and attached to the rotating shaft 9 provided on the handle part 13, and the guide plate 14 that guides rotation of the rotating-shaft receiving shaft 8 is provided on the handle part 13 such that the friction resistance between the rotating shaft 9, the rotating-shaft receiving shaft 8, and the guide plate 14 can be varied.

Description will be given for an embodiment 2 of the present invention with FIGS. 12 to 17.

FIG. 12 is the brush material 1 in which center part of the brush material shown in FIG. 4 is subjected to ultrasonic welding 6, that has the opening part 7 having the hexagonal shape at the center part and has an outer peripheral provided to have a square shape 4.

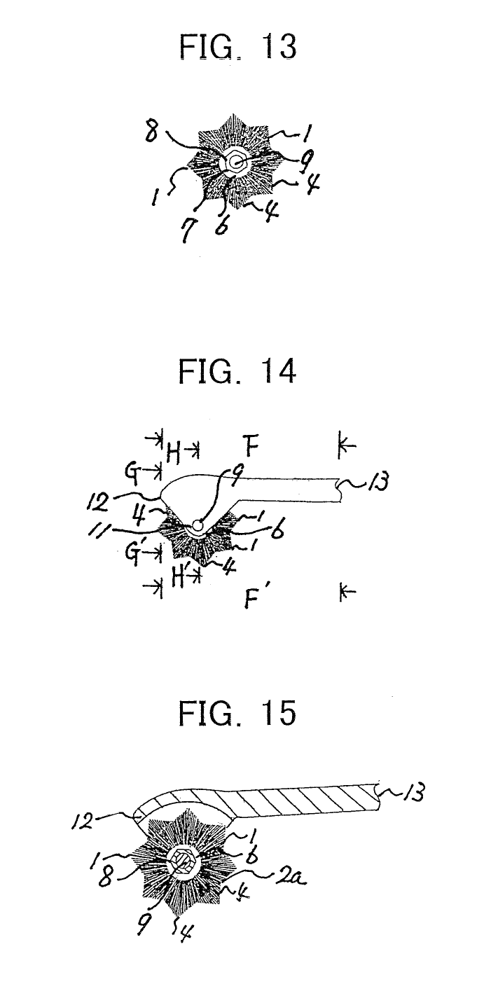

FIG. 13 shows a state where the brush material 1 provided to have the square shape 4 shown in FIG. 12 above is attached to the rotating-shaft receiving shaft 8 at a different rotation angle. 6 denotes the welding part, 7 denotes the opening part, and 9 denotes the rotating shaft.

FIG. 14 is the toothbrush having the polygonal shape, in which, as described in FIG. 13 above, the brush material 1 having the square shape 4 attached to the rotating-shaft receiving shaft is attached to the rotating-shaft receiving shaft at a different rotation angle alternately, and the rotating shaft 9 is attached to the hole 10a of the mounting parts 11 of the fore-end part 12 of the handle part 13 to form the brush part 2a, so as to appear to be in the gear shape from side. 6 denotes the welding part.

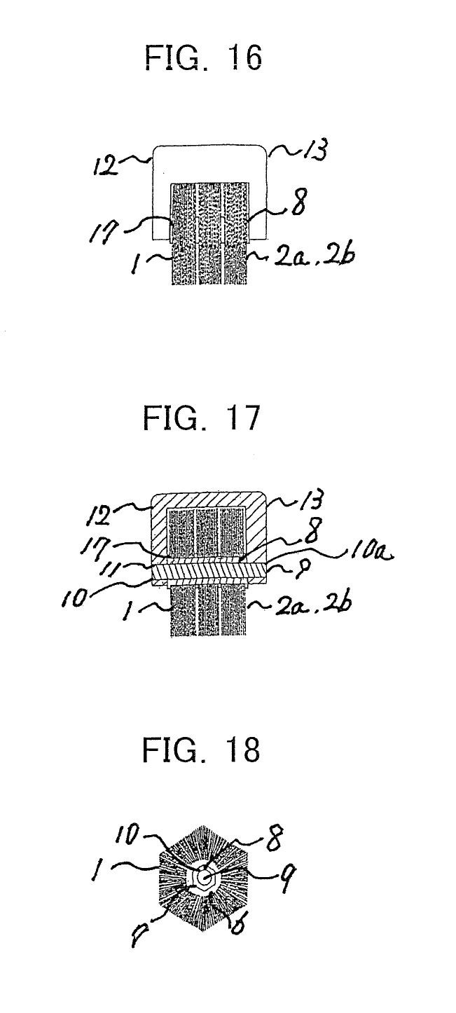

FIG. 15 is an enlarged transverse central section view of an F-F′ portion of FIG. 14. As described in FIG. 13 above, it is the toothbrush having the polygonal shape, in which the brush material 1 having the square shape 4 is attached to the rotating-shaft receiving shaft 8 at a different angle alternately, and therefore the side shape of the toothbrush having a polygonal shape appears to be in the gear shape. Moreover, the toothbrush is configured so that the brush material 1 is attached, at the rotating-shaft receiving hole 10 thereof, to the rotating shaft 9 provided on the handle part 13 such that the friction resistance between the rotating shaft 9 and the rotating-shaft receiving hole 10a of the brush material 1 can be varied, and 12 denotes the fore-end part of the handle part 13, 6 denotes the welding part, 7 denotes the opening part, and 2a denotes the brush part.

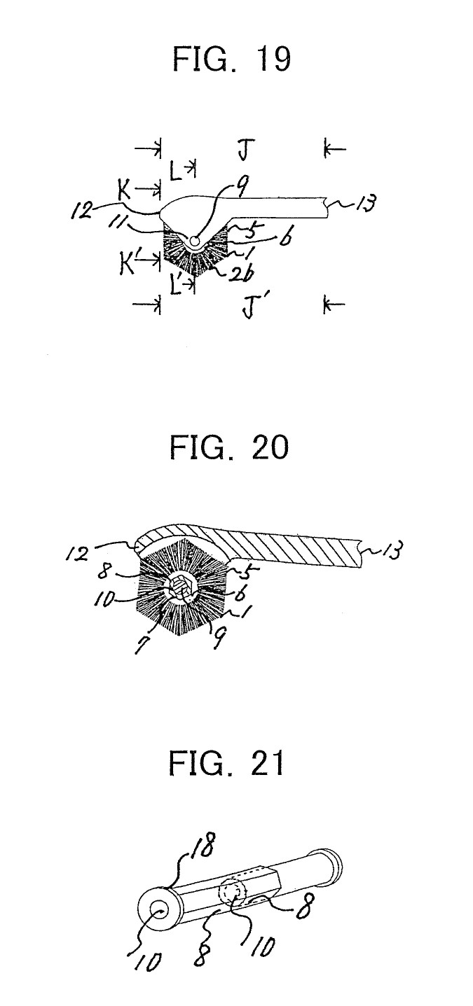

FIG. 16 is an enlarged front view in a G-G′ direction of FIG. 14. As shown in the section view of FIG. 17 the brush material 1 is attached to the rotating-shaft receiving shaft the rotating shaft is inserted into the receiving hole 10 of the rotating-shaft receiving shaft 8, and the rotating shaft 8 is attached to the hole 10a of the mounting parts 11 at right and left of the fore-end part 12 of the handle part 13. Moreover, 2a denotes the brush part, and 2b denotes the brush part of a front view in a K-K′ direction of FIG. 19 in an embodiment 3 that is depicted in the same shape.

FIG. 17 is an enlarged section view showing an H-H′ direction of FIG. 14. The brush material 1 is attached to the rotating-shaft receiving shaft 8, the rotating shaft 9 is inserted into the receiving hole 10 of the rotating-shaft receiving shaft 8, the rotating shaft 9 is attached to the hole 10a of the mounting parts 11 at right and left of the fore-end part 12 of the handle part 13, and the brush part 2a is formed with the brush material 1. Note that, 2b denotes the brush part of a section view in an L-L′ direction of FIG. 19 in an embodiment 3 that is depicted in the same shape.

Description will be given for the embodiment 3 of the present invention with FIG. 18 to FIG. 20.

FIG. 18 shows a state where the brush material 1 provided to have the hexagonal shape 5 is attached to the rotating-shaft receiving shaft 8 at the same rotation angle. 6 denotes the welding part, 7 denotes the opening part, 9 denotes the rotating shaft, and 10 denotes the receiving hole of the rotating-shaft receiving shaft 8.

In FIG. 19, the brush material 1 is attached to the rotating-shaft receiving shaft 8 described in FIG. 18, and the rotating shaft 9 is inserted into the receiving hole 10 of the rotating-shaft receiving shaft to be attached to the hole 10a of the mounting parts 11 at right and left of the fore-end part 12 of the handle part 13. The toothbrush is configured so that the brush material 1 is attached, at the rotating-shaft receiving hole 10a thereof, to the rotating shaft 9 provided on the handle part 13 such that the friction resistance between the rotating shaft 9 and the rotating-shaft receiving hole 10 of the brush material 1 can be varied. Moreover, 5 denotes the brush part having the hexagonal shape.

FIG. 20 is an enlarged transverse central section view of a J-J′ portion of FIG. 19. As described in FIG. 18, the opening part 7 provided to have the hexagonal shape 5a at the center part of the brush material 1 is attached to the rotating-shaft receiving shaft 8. In addition, the toothbrush is configured so that the brush material is attached, at the rotating-shaft receiving shaft 10 thereof, to the rotating shaft 9 provided on the handle part 13 such that the friction resistance between the rotating shaft 9 and the rotating-shaft receiving hole 10 of the brush material 1 can be varied.

In FIG. 21, the rotating shaft 8 of FIG. 23 and the receiving hole 10 of the rotating-shaft receiving shaft 8 whose left end has a cylindrical shape are provided on the rotating-shaft receiving shaft 8 whose left end has a polygonal shape. Moreover, 18 denotes a stopper for preventing a fall when the brush material 1 is attached to the rotating-shaft receiving shaft 8. There is a reference perspective view.

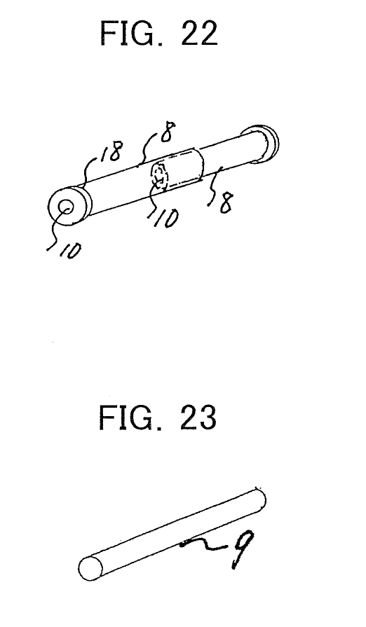

In FIG. 22, on the rotating-shaft receiving shaft 8 whose left end has a cylindrical shape, the rotating shaft 8 of FIG. 23 and the receiving hole of the rotating-shaft receiving shaft 8 whose left end has the same shape as the left end are provided. Moreover, 18 denotes a stopper for preventing a fall when the brush material 1 is attached to the rotating-shaft receiving shaft 8. There is a reference perspective view.

FIG. 23 is a perspective view of the rotating shaft 9 which is inserted into the receiving hole 10 of the rotating-shaft receiving shaft 8 of FIG. 21 and FIG. 22 above.

As described in the embodiments 1, 2 and 3 above, the toothbrush is configured so that the friction resistance between both or either one of the guide plate, and the rotating shaft and the rotating-shaft receiving shaft can be varied.

As described above, the toothbrush is that it is possible to obtain variable rotation means by being provided such that the friction resistance between the guide plate 15 provided inside the fore-end part 12 of the handle part 13, the rotating-shaft receiving shaft 8, and the rotating shaft 8 can be varied.

Differently from a toothbrush which rotates on front and rear faces of teeth like a conventional rotary toothbrush, the toothbrush having the gear shape is that by providing an outer peripheral of the brush part 2, 2a2b to have a gear shape or a polygonal shape, bristle tips of the fore-end part of the brush part easily enters not only on the front and rear faces of teeth but spaces between teeth when toothbrushing even at any angle, and as a consequence, of course, an effect of removing plaque and the like becoming a cause of periodontal disease, as well as a massaging effect on gums can be expected, which is the toothbrush having the gear shape and the polygonal shape by which there is no unbrushed part between teeth.

### REFERENCE SIGNS LIST

1: brush material
2, 2a, 2b: brush part
3: gear shape
4: square shape
5, 5a, 5b: hexagonal shape
6: welding part
7: opening part
8: rotating-shaft receiving shaft
9: rotating shaft
10, 10a, 10b: hole
11: mounting part
12, 12a: fore-end part
13: handle part
14: guide plate
15: wire
16: bristle
17: washer
18: stopper
A-A′, B-B′, C-C′, D-D′ E-E′, F-F′, G-G′, H-H′
J-J′, K-K′, L-L′: direction

1. A toothbrush comprising:
a rotating-receiving shaft of a brush material fitted and attached to a rotating shaft provided on a handle part, a guide plate that guides rotation of the rotating-shaft provided on the handle part, in order to make it possible to vary friction resistance between the rotating-receiving shaft and the guide plate, in a case where the rotating-receiving shaft is mounted to the handle part, when a certain amount of friction resistance is exceeded during toothbrushing, the rotating-receiving shaft has a polygonal shape and is supported to be rotatable by a semicircular portion of a lower part of the guide plate, the rotating shaft is inserted into a hole provided at the rotating-shaft receiving shaft to be mounted to the handle part, and when the certain amount of friction resistance is exceeded during toothbrushing, the rotating-receiving shaft is configured to be rotatable.

2. A toothbrush comprising:
a rotating-receiving shaft of a brush material attached to a rotating shaft provided on a handle part, and in order to make it possible to vary friction resistance between the rotating shaft and a hole of the rotating-receiving shaft of the brush material, a gap between the rotating shaft and the rotating-receiving shaft is provided tightly in a rotatable range, and when a certain amount of friction resistance is exceeded during toothbrushing, the rotating-receiving shaft is configured to be rotatable.

3. The toothbrush as defined in claim 2, wherein
the brush material is attached to the rotating-receiving shaft at a different rotation angle.

4. The toothbrush as defined in claim 2, wherein
the brush material is attached to the rotating-receiving shaft at a same rotation angle.
